(19) United States
(12) Patent Application Publication
(10) Pub. No.: US 2026/0030798 A1
(43) Pub. Date: Jan. 29, 2026

(54) EFFICIENT COMPRESSION MODE SELECTION FOR BC7 TEXTURE ENCODING

(71) Applicant: Sony Interactive Entertainment LLC, San Mateo, CA (US)

(72) Inventor: Thomas Madams, San Mateo, CA (US)

(21) Appl. No.: 18/786,447

(22) Filed: Jul. 27, 2024

(51) Int. Cl. G06T 11/00; G06T 9/00

(52) U.S. Cl. CPC G06T 11/001; G06T 9/00; G06T 2210/08

(57) ABSTRACT

Techniques are described for quickly finding a compression mode for BC7 encoding by modelling three sources of error in compression, namely, projection error, endpoint quantization error, and interpolation index quantization error. The mode with the lowest total error is selected for a block to be compressed.

### FIELD

The present application relates to technically inventive, non-routine solutions that are necessarily rooted in computer technology and that produce concrete technical improvements, and more specifically to efficient compression mode selection for BC7 texture encoding.

### BACKGROUND

In computer simulations such as computer gaming, objects are rendered in part using “texture” data that describes the surfaces of the objects. The more texture data for a given object, the higher resolution the rendering can be. However, for bandwidth purposes it is desirable not to send large texture data structures to a rendering device.

### SUMMARY

As understood herein, to conserve memory, texture data is usually compressed into one of a variety of block compression (BCn) modes that are natively sample-able on GPUs. BC7 is of particular relevance to present principles, which seek to quickly find a BC7 compression mode.

Accordingly, an apparatus includes at least one processor system configured to, for at least a first block of computer graphics texture data, determine a projection error estimate, an endpoint quantization error estimate, and an interpolation index quantization error estimate for plural block compression (BC) modes. The processor system is configured to, based at least in part on the estimates, select a first one of the BC modes, and compress the first block using the first mode.

In some examples the plural BC modes include plural BC7 modes.

In example implementations the processor system can be configured to render the texture data on at least one video display at least in part by processing the first block compressed using the first mode.

In certain embodiments the processor system is configured to select the first one of the BC modes responsive to the first one of the BC modes having a lowest total sum of the estimates among the BC modes.

When BC7 is used, the processor system may be configured to determine a first projection error estimate for BC7 mode 6, a second projection error estimate for BC7 modes 4 and 5, a third projection error estimate for BC7 modes 1 and 3 and in some cases, 7, and a fourth projection error estimate for BC7 modes 0 and 2. Mode 7 may in some embodiments be treated separately, and a projection error estimate generated just for mode 7. On the other hand, the processor system can be configured to determine individual respective endpoint quantization error estimates for respective BC7 modes 0, 1, 2, 3, 4, 5, 6, and 7 and likewise to determine individual respective interpolation quantization error estimates for respective BC7 modes 0, 1, 2, 3, 4, 5, 6, and 7.

In an example embodiment, the processor system can be configured to determine the interpolation index quantization error estimate at least in part by quantizing interpolation index values from a set of scalar values in a range to N-bits. In a more specific example, the processor system can be configured to determine the interpolation index quantization error estimate at least in part by quantizing interpolation index values from a set of scalar values in a range to N-bits of precision and quantizing endpoints in the values to M-bits of precision, and approximate a combined error term from the quantizing to a piecewise linear function. In another specific example, the processor system can be configured to determine the interpolation index quantization error estimate at least in part by quantizing interpolation index values from a set of scalar values in a range to N-bits of precision and quantizing endpoints in the values to M-bits of precision, and approximate a combined error term from the quantizing to a piecewise quadratic function.

In another aspect, a device includes at least one computer storage that is not a transitory signal and that in turn includes instructions executable by at least one processor system to select a block compression (BC)7 mode of compression with which to compress at least one block of data without compressing the block with every available mode of compression to determine which mode minimizes compression error. This selection is achieved at least in part using projection error estimates and/or endpoint quantization error estimates and/or interpolation index quantization error estimates for plural BC7 modes.

In another aspect, a method includes determining one or more estimates of errors related to potential compression of a block of information, and using the one or more estimates and without compressing the block with every available mode of compression to determine which mode minimizes compression error, select a mode of compression to compress the block using the one or more estimates.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example block compression (BC) system;

FIG. 3 illustrates projection error;

FIG. 4 illustrates endpoint quantization error;

FIG. 5 illustrate interpolation index quantization error;

FIG. 6 illustrates example logic in example flow chart format for selecting a compression mode for BC7 compression using estimates of the errors of FIGS. 3-5 for each mode that is a candidate to compress a block;

FIG. 7 illustrates further details of the example logic of FIG. 6 in example flow chart format;

FIG. 8 illustrates details of channel rotation from FIG. 7 in example flow chart format;

FIG. 9 illustrates details of approximating a best axis from FIG. 7 in example flow chart format;

FIG. 10 illustrates a graph consistent with FIG. 9;

FIG. 11 illustrates details of estimating interpolation index quantization error from FIG. 7 in example flow chart format;

FIGS. 12 and 13 illustrate graphs consistent with FIG. 11;

FIG. 14 illustrates details of determining MAE combined quantization error from FIG. 7 in example flow chart format;

FIGS. 15-18 illustrate graphs consistent with FIG. 14; and

FIGS. 19-22 illustrate graphs depicting MSE error.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

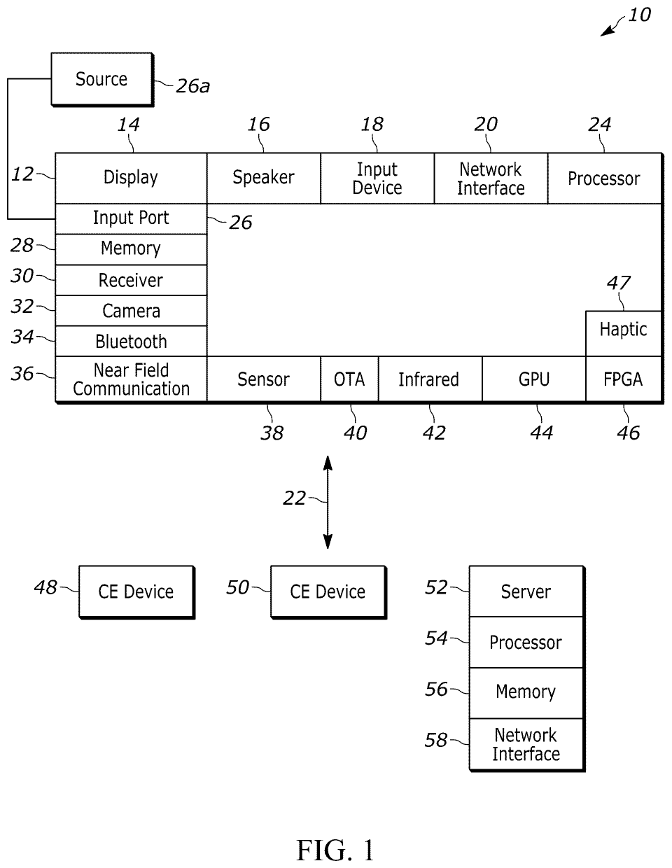

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12.

The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom.

Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command).

The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

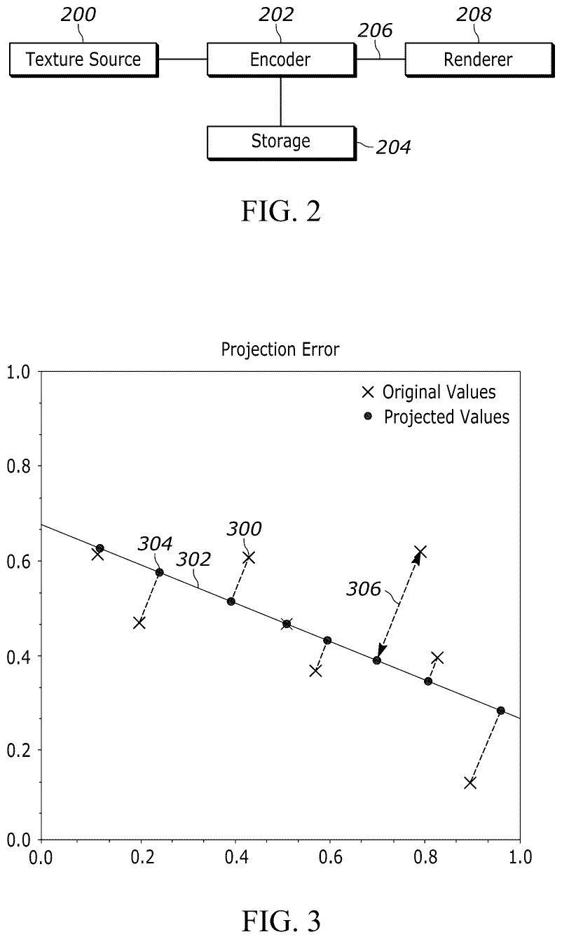

Prior to turning to FIG. 2, “textures” are data structures that can be mapped onto images to characterize the surfaces of the rendered objects. The basic data element of a texture data structure is a texture element or texel (combination of texture and pixel). Textures are represented by arrays of texels representing the texture space. The texels are mapped to pixels in an image to be rendered to define the rendered surface of the image. Disclosure herein may refer to “pixels” instead of “texels”.

Various types of compression may be used on textures. One type is block compression, sometimes expressed as BCn compression that is a lossy texture compression which can be decompressed in-place by graphics processing units (GPUs). Block compression does not require the whole image to be decompressed, so the GPU can decompress the data structure while sampling the texture as though it was not compressed at all.

Block compression techniques compress 4×4 blocks of pixels into a single (smaller) data packet. Generally, this involves selecting two or more (depending on the BC compression type) “endpoint” colors with some information per-pixel about how to blend between those two colors at each pixel. The endpoint colors are shared for the entire 4×4 pixel block. For instance, for an image of only red, blue, and purple pixels, the compressor would likely choose one end point to be red, and the other blue. The purple pixels would have values that blend the two together.

The different BC types mostly differ in how many texture channels they have (BC4 for instance is one channel grayscale, “black and white”). BC6 and BC7 are special because they introduce the concept of modes that decide the interpretation of each block. With BC6/7 different modes allocate their bits differently on a per-block basis which allows the encoder/compressor to make different quality trade-offs in different regions of a texture.

With specific regard to BC7 and consistent with the above, textures are subdivided into fixed size 4×4 blocks, and each block is compressed to a fixed number of bits (e.g., BC7 uses 128 bits per block). Ignoring partitions for now, pixels in a block are represented by a single pair of endpoint colors, shared between all pixels in the block and a 16 per-pixel interpolation index values, which define how much to blend between the two endpoint colors. A pixel's color in the compressed block is calculated by blending between the two endpoint colors by the amount specified by the pixel's interpolation index.

A single pair of endpoint colors can compress a block with low error if all pixels in a block are well-approximated by a blend of those two colors. On the other hand, if a block contains more than two very different colors, it is impossible to define two endpoint colors for which this approximation holds. Accordingly, to address this problem, several modes in BC7 partition a 4×4 block into two or three subsets, and each subset has its own pair of endpoint colors. Multi-subset modes necessarily have lower precision endpoints and interpolation indices because they must fit extra endpoint colors in the same 128 bits as block modes that do not use partitions. A block's partition must be one of sixty four (64) predetermined patterns that are fixed and defined in the BC7 specification. Selecting the “best” partition of the sixty four currently requires an essentially exhaustive test/search process. Techniques described in co-pending U.S. patent application Ser. No. 18/348,657, incorporated herein by reference, provide an efficient way to select an effective partition.

Additionally and apart from the issue above of selecting a best partition, BC7 supports eight different compression modes, each of which makes its own respective trade-off between endpoint color precision and interpolation index precision (among other things). The mode used to encode each block is signaled in the first few bits of the encoded data. Generally, modes with higher precision endpoint colors have lower precision interpolation indices, and vice-versa. Depending on the mode used to compress a block, interpolation indices will be either 2-bit, 3-bit or 4-bit per pixel.

More specifically, BC7 compression, as an example, works by representing the pixels in a 4×4 block (or subset for multi-subset modes) as a pair of endpoint colors and per-pixel interpolation values between the two colors. The endpoint colors are shared by all pixels in the block or subset and as such are moderate-to-high precision, whereas the interpolation values are per-pixel and as such are low-to-moderate precision (a 2, 3, or 4-bit value). Several modes are similar but make different trade-offs between endpoint and interpolation precision:

Modes 0 and 2 have Three Subsets:
Mode 0: 4-bit RGB endpoint colors, 3-bit interpolation values
Mode 2: 5-bit RGB endpoint colors, 2-bit interpolation values
   Modes 1 and 3 have Two Subsets:
Mode 1: 6-bit RGB endpoint colors, 3-bit interpolation values
Mode 3: 7-bit RGB endpoint colors, 2-bit interpolation values
   Modes 4 and 5 are a Single Subset with have Two Sets of Interpolation Values (One for RGB and the other for A):
Mode 4: 5-bit RGB, 6-bit A endpoint colors, 2 and 3-bit interpolation values
Mode 5: 7-bit RGB, 8-bit A endpoint colors, 2 and 3-bit interpolation values

Whether the 3-bit indices in mode 4 are used for RGB or A is signaled by a control bit in the compressed block.

Current techniques for selecting the best compression mode for BC7 textures is to conduct an exhaustive search, in which every mode is tested and the one selected that minimizes compression error. Techniques herein describe an efficient way to select a compression mode for a BC7 texture without having to conduct an exhaustive search in which every mode is tested and the one selected that minimizes compression error. That is, present techniques avoid compressing a block of texture with every available mode of compression to determine which mode minimizes compression error.

While disclosure herein focuses on BC7, present techniques may find application for other block compression modes.

Accordingly, turn now to FIG. 2, which illustrates a texture source 200 that sends textures to an encoder 202 such as a BC6 or BC7 encoder. While discussion below uses BC7 as an example, present principles apply to other compression modes such as BC6.

The encoder 202, which in a hardware implementation includes a processor assembly configured according to principles herein, processes the textures according to principles herein and stores compresses textures in one or more storages 204 and/or sends the compressed textures via a communication path 206 such as a local data bus or wired/wireless network link to a texture renderer 208, which typically includes one or more processors such as GPUs with memories to render images in accordance with image data and texture data on a display.

Present principles recognize that BC7 compression introduces distortion (compression artifacts) from three sources. The first is projection error, caused by approximating true pixel colors by interpolating (blending) between two endpoint colors. The second source of error is endpoint quantization, caused by representing the endpoint colors using fewer than 8-bits per color channel. The third source of error is interpolation index quantization, caused by storing the per-pixel interpolation amounts using low precision indices (as low as 2 bits per pixel).

FIGS. 3-5 illustrate these sources of error. FIG. 3 simplifies visualizing the projection error problem by considering only two color channels plotted on a graph, one color, e.g., red on the X-axis and the other color such as green on the Y-axis. The closest colors representable as a blend of two endpoint colors are found by projecting the original values 300 (denoted by “X” in FIG. 3) of the colors onto a best fit line 302 to projected values 304 on the line 302. The projection error is the total sum of the distances 306 between the original values 300 and their projected values 304, i.e., the total length of the dotted lines in FIG. 3. As recognized herein, projection error is often significant, especially for BC7 compression modes that do not support multiple subsets.

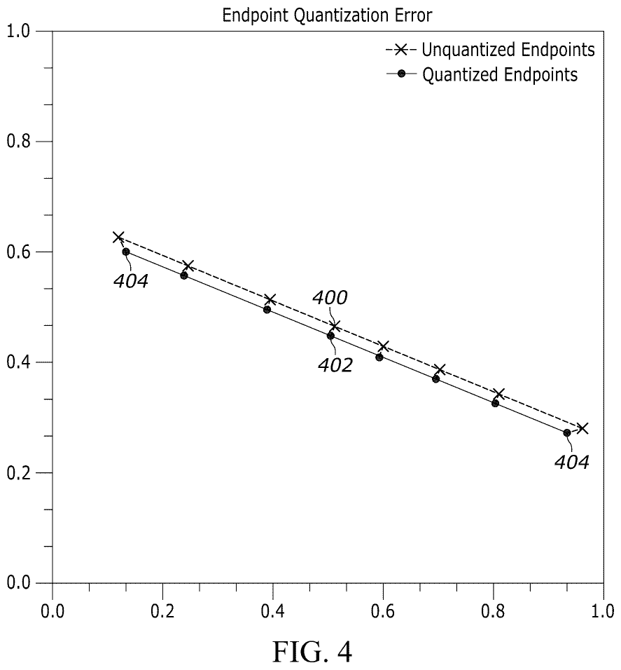

FIG. 4 illustrates endpoint quantization error. The endpoints are stored using reduced precision, e.g. 5-bits per pixel instead of 8-bits. FIG. 4 illustrates this by quantizing the endpoint colors 400 to the closest representable 4-bit value 402. Note how the two quantized endpoint colors are aligned to vertices 404 on the background grid. Present principles recognize that endpoint quantization error is often smaller than projection error but can introduce visible distortion in some cases, e.g., smooth gradients.

Example pseudocode to implement the above follows:

```
def index_quantization_scale(N)
  range ← 2^{N} − 1
  return 1 / (4 * range)
def endpoint_quantization_scale_and_bias(M, N)
  if M ≥ 8 then
    scale ← 0
    bias ← 0
  else
    scale ← (1 / 2^{N} − 1) / 4
    bias ← 64 / 2^{M}
  end
  return scale, bias
def channel_quantization_error(Cₘᵢₙ, Cₘₐₓ, M, N, error_type)
  i_scale ← index_quantization_scale(N)
  e_scale, e_bias ← endpoint_quantization_scale_and_bias(M, N)
  i_error ← i_scale * (Cₘₐₓ − Cₘᵢₙ)
  e_error ← max(e_scale * (Cₘₐₓ − Cₘᵢₙ) + e_bias, 0)
  if error_type == “MAE” then
    error ← max(i_error, e_error)
  else if error_type == “MSE” then
    error ← (4/3) * max(i_error², e_error²)
  end
  return error
def quantization_error(pixels, C, M, N, error_type)
  error ← 0
  for I in 0:C do
    Cₘᵢₙ ← minimum value of channel C in pixels
    Cₘₐₓ ← maximum value of channel C in pixels
    error ← error + channel_quantization_error(Cₘᵢₙ, Cₘₐₓ, M, N, error_type)
  end
  return error
# Returns an estimate for the quantization resulting from compressing an
# array of pixels using the given mode.
# - pixels: array of pixels to estimate the quantization error for
# - mode: the mode to estimate quantization error for
# - error_type: example implementations for “MSE” and “MAE” error provided
# - rotation: optional channel rotation for modes that support it (4 & 5)
def quantization_error_for_mode(pixels, mode, error_type, rotation)
  if mode == 4 ∥ mode == 5 then
    # Modes 4 and 5 support channel rotation:
    # - apply the rotation to yield the rotated array pixels_{R′G′B′A′}
    # - separate the RGBA pixels array into two new arrays:
    # - rotated RGB array pixels_{R′G′B′}
    # - rotated A array pixels_{A′}
    pixels_{R′G′B′A′} ← apply_channel_rotation(pixels)
    pixels_{R′G′B′}, pixels_{A′} ← separate_RGB_and_A(pixels_{R′G′B′A′})
  end
  if mode == 4 then
    # Mode 4 supports an index bit that controls whether the 3-bit
    # interpolation indices are assigned to rotated R′G′B′ or rotated A’.
    # Compute the quantization error estimate for both ways and choose the
    # smallest.
    error_{R′G′B′} ← quantization_error(pixels, 3, 5, 2, error_type)
    error_{A′} ← quantization_error(pixels, 1, 6, 3, error_type)
    error₄₀ ← error_{R′G′B′} + error_{A′}
    error_{R′G′B′} ← quantization_error(pixels, 3, 5, 3, error_type)
    error_{A′} ← quantization_error(pixels, 1, 6, 2, error_type)
    error₄₁ ← error_{R′G′B′} + error_{A′}
    error ← min(error₄₀, error₄₁)
  else if mode == 5 then
    error_{R′G′B′} ← quantization_error(pixels, 3, 7, 2, error_type)
    error_{A′} ← quantization_error(pixels, 1, 8, 2, error_type)
    error ← error_{R′G′B′} + error_{A′}
  else
    case mode of
      0: C, M, N ← 3, 4, 3
      1: C, M, N ← 3, 6, 3
      2: C, M, N ← 3, 5, 2
      3: C, M, N ← 3, 7, 2
      6: C, M, N ← 4, 7, 4
      7: C, M, N ← 4, 6, 2
    end
    error ← quantization_error(pixels, C, M, N, error_type)
  end
  return error
```

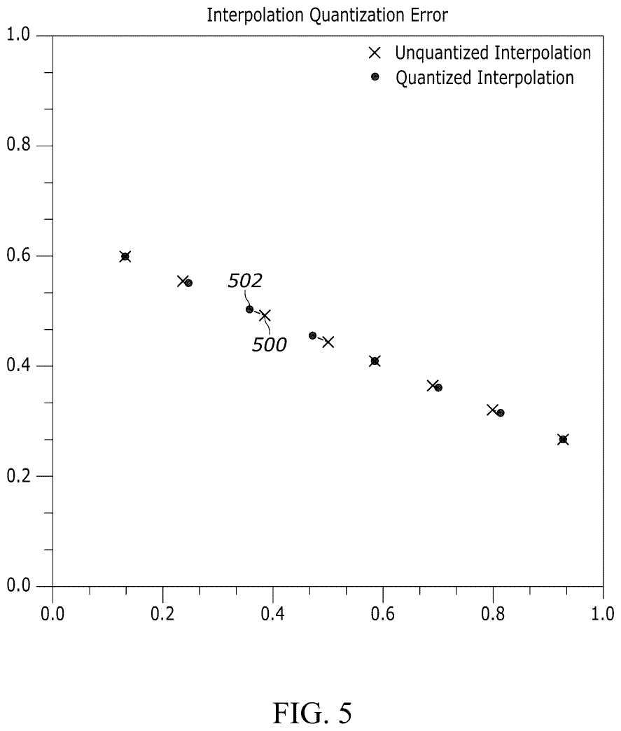

FIG. 5 illustrates interpolation index approximation error. The amount to blend between the two endpoint colors is stored as per-pixel 2-, 3-, or 4-bit values. Consequently, the representable colors in a BC7 block or subset are made up of a small palette of color: 4 colors for 2-bit indices, 8 colors for 3-bit indices, and 16 colors for 4-bit indices. The colors are uniformly distributed between the endpoints. As shown in FIG. 5, for 3-bit interpolation indices, the projected colors 500 are snapped to the closest color 502 in the palette. As understood herein, interpolation index quantization error can be significant particularly for modes that support only 2-bit interpolation indices and for blocks or subsets where the endpoints are far apart.

With the above in mind, present principles provide techniques to choose a high-quality mode with which to compress a block without having to conduct an exhaustive search in which every mode is tested and the one selected that minimizes compression error. Present techniques are near optimal in the average case, assuming a uniform distribution of colors.

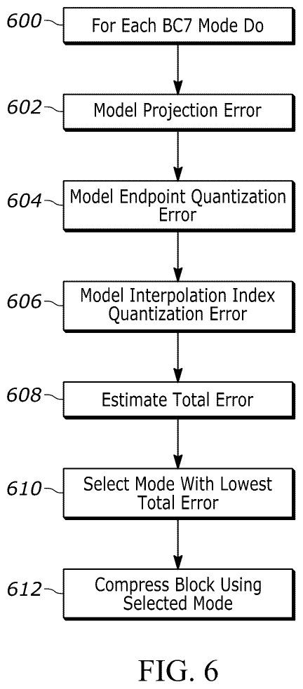

As shown at state 600 in FIG. 6, for each BC7 mode that can be potentially compress a block of texture data, present techniques model the above three sources of error, namely, projection error (state 602), endpoint quantization error (state 604), and interpolation index quantization error (state 606). At state 608 the total error for the mode under test is estimated, with the mode having the lowest total error being selected at state 610 to compress the block at state 612. Note that different error terms may be used. For example, mean absolute error (MAE) or mean squared error (MSE) may be used.

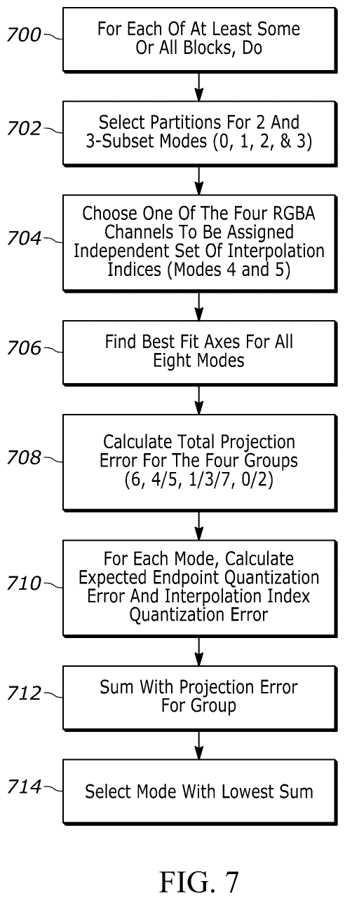

FIG. 7 illustrates a more detailed logic flow reflecting the principles of FIG. 6. Commencing at state 700, for each texture block of some and preferably all blocks, the logic proceeds to state 702 to select the partition patterns to consider for 2- and 3-subset modes (modes 0, 1, 2, and 3). In one example, this may be done using the partition selection techniques in the above-referenced patent application. Thus, state 702 applies to modes 0, 1, 2, 3, and 7 only.

Proceeding to state 704, for modes 4 and 5 only (which have alpha channels), one of the four channels (R, G, B, and A) is selected to be assigned its own independent set of interpolation indices. Channel rotation swaps one color channel with the alpha channel, and the resulting “rotated” RGB colors (referred to herein as R′G′B′) are assigned one set of interpolation indices while the “rotated” alpha values (A′) are assigned a second set of interpolation indices.

Moving to state 706, for all eight BC7 compression modes, the best fit axes are identified. This includes identifying the whole-block best fit RGBA axis for mode 6, the whole-block best fit rotated R′G′B′ axis for modes 4 and 5, the 2-subset best fit RGB axes for modes 1, 3, the 2-subset best fit RGBA axes for mode 7, and the 3-subset best fit RGB axes for modes 0 and 2. One best-fit axis is calculated for the pixels in each subset, i.e., one best-fit axis is calculated for mode 6, another for modes 4 and 5 collectively, two best-fit axes are calculated for modes 1 and 3 collectively, two further best-fit axes are calculated for modes 0 and 2 collectively, and finally two best-fit axes are calculated for mode 7.

Proceeding to state 708, the total projection error for the above four cases is calculated using the respective best fit axes.

Moving to state 710, for each of the eight potential BC7 compression modes, the expected endpoint quantization error and interpolation index quantization error are calculated. These eight endpoint quantization errors and interpolation index quantization errors are summed at state 712 with the corresponding projection error from state 708 for the group each respective mode is in. The mode with the lowest total error is selected at state 714 to compress the block under test.

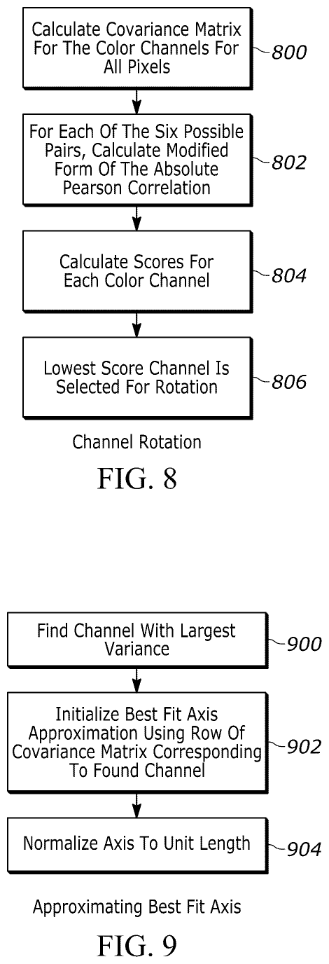

FIG. 8 illustrates details of state 704 in FIG. 7. Commencing at state 800, the covariance matrix for the color channels for all pixels is calculated. Moving to state 802, for each of the six possible pairs of color channels (red-green, red-blue, red-alpha, green-blue, green-alpha, blue-alpha) a modified form of the absolute Pearson correlation is calculated, which has the value 1.0 if one or both channels has zero variance. More specifically, for channels X, Y:

$${ρ}_{X , Y}^{′} = \{ \begin{matrix}\vert \frac{cov ( X , Y )}{{σ}_{X} {σ}_{Y}} \vert , & {σ}_{X} {σ}_{Y} > ϵ \\ 1 , & {σ}_{X} {σ}_{Y} \leq ϵ\end{matrix}$$

Where cov(X, Y) is the covariance of channels X & Y, σ_{X} is the standard deviation of channel X, σ_{Y} is the standard deviation of channel Y, and ϵ is a small constant used to prevent division by zero and numerical precision issues.
   Proceeding to state 804, the following scores for each color channel are calculated: score_{R}=ρ′_{R,G}+ρ′_{R,B}+ρ′_{R,A}, score_{G}=ρ′_{R,G}+ρ′_{G,B}+ρ′_{G,A},score_{B}=ρ′_{R,B}+ρ′_{G,B}+ρ′_{B,A}, and score_{A}=ρ′_{R,A}+ρ′_{G,A}+ρ′_{B,A}

The channel with the lowest score is the channel selected for rotation. Note that this is one of many possible heuristics that could be used to choose the alpha channel, and if desired, the technique of FIG. 8 can be combined with other heuristics, e.g., always assign the alpha channel the second set of indices if the alpha channel represents opacity and any pixel in the block is non-opaque.

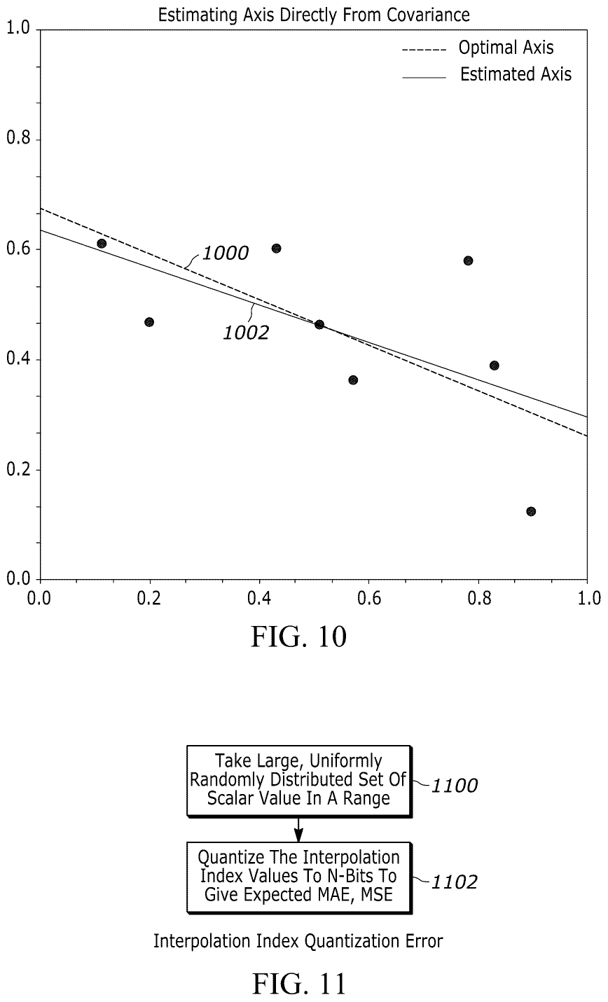

FIGS. 9 and 10 illustrate approximating a best fit axis consistent with state 706 in FIG. 7. The true best fit axis for the pixels in a block or subset can be calculated from their covariance matrix using the power iteration method. On the other hand, for real-time use cases, an approximate axis can be calculated directly from the covariance matrix by identifying, at state 900, the channel that has the largest variance. Moving to state 902, the best fit axis approximation is initialized using the values from the row of the covariance matrix corresponding to the channel with the largest variance. The axis is normalized to unit length at state 904. FIG. 10 illustrates.

In FIG. 10, the optimal axis 1000 is shown in dotted lines, while the estimates axis 1002 is shown in solid.

Note that the approximation in FIGS. 9 and 10 is used only to calculate the projection error term. After the mode has been chosen, the true best fit axis is calculated to perform block compression.

FIGS. 11-13 illustrate estimating interpolation index quantization error consistent with FIG. 7. An estimate for the interpolation index quantization error may be calculated by modeling an idealized problem. Commencing at state 1100 in FIG. 11, a large, uniformly randomly distributed set of scalar (1-dimensional) values in the range [Xₘᵢₙ, Xₘₐₓ] is accessed/identified. Xₘᵢₙ is the minimum value of channel X of the pixels in the block or subset while Xₘₐₓ is the maximum value of channel X of the pixels in the block or subset. Note that in general, random numbers need not be used, the goal being to minimize the expected error of an unknown set of pixels that are uniformly randomly distributed between the two endpoint colors. Here, “expected” is used in the well defined mathematical sense of “expected value”: the average error obtained from a countably infinite number of random pixels.

Moving to state 1102, the interpolation index values are quantized to N-bits to give the following closed form expected error. Mean absolute error is given by

$$MAE = \frac{1}{4} ( \frac{{X}_{max} - {X}_{min}}{{2}^{N} - 1} )$$

whereas mean squared error is given by

$$MSE = \frac{1}{12} {( \frac{{X}_{max} - {X}_{min}}{{2}^{N} - 1} )}^{2} .$$

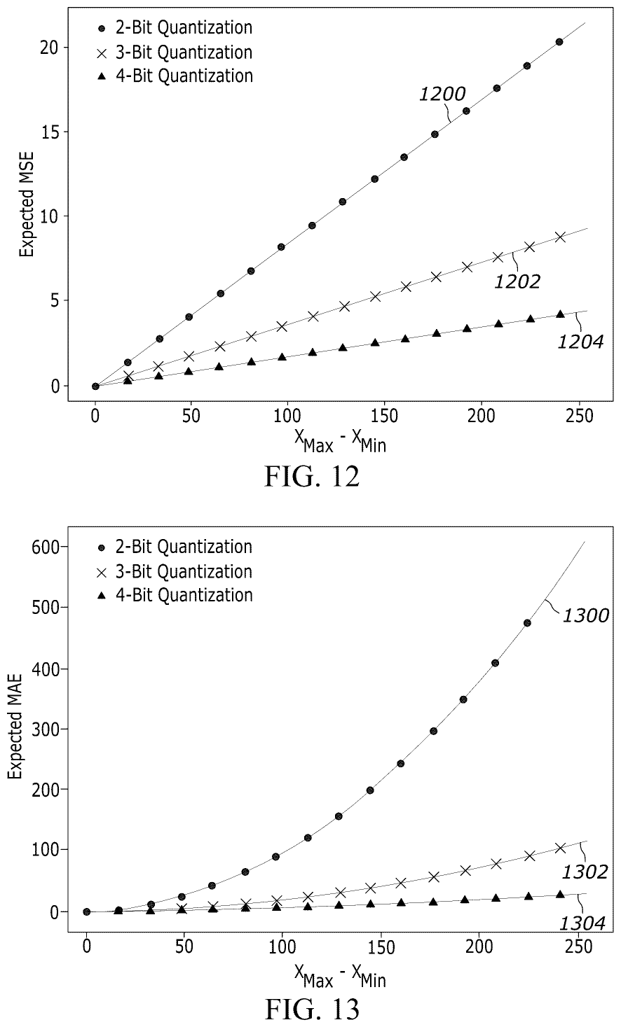

FIGS. 12 and 13 respectively illustrate expected MSE and expected MAE on the respective y-axes versus the range discussed above on the respective x-axes. FIG. 12 illustrates the expected MSE for 2-bit quantization 1200, 3-bit quantization 1202, and 4-bit quantization 1204. FIG. 13 illustrates the expected MAE for 2-bit quantization 1300, 3-bit quantization 1302, and 4-bit quantization 1304.

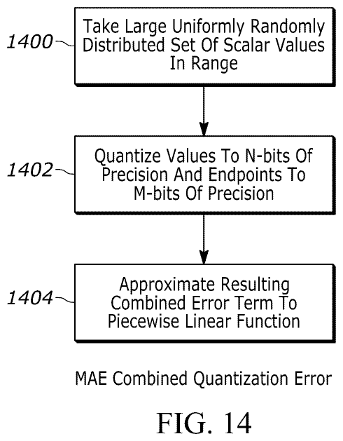

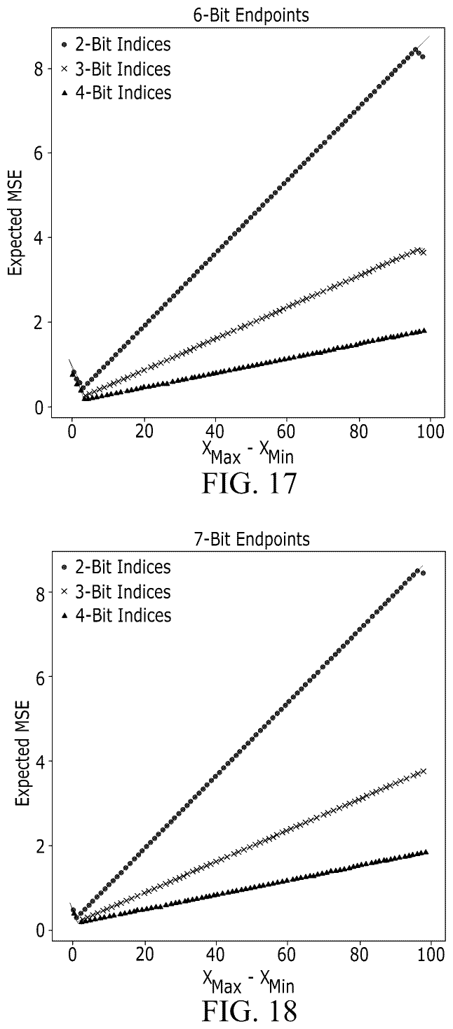

FIGS. 14-18 extend the idealized problem presented in FIGS. 11-13 to also account for endpoint quantization error. State 1400 takes (as an example) a large, uniformly randomly [symbol] distributed set of scalar (1-dimensional) values in the range [X_min [symbol] ,X_max] which are quantized at state 1402 to N-bits of precision. The endpoints are quantized to M-bits of precision. The resulting combined error term is complex but can be efficiently approximated as a piecewise linear function at state 1404.

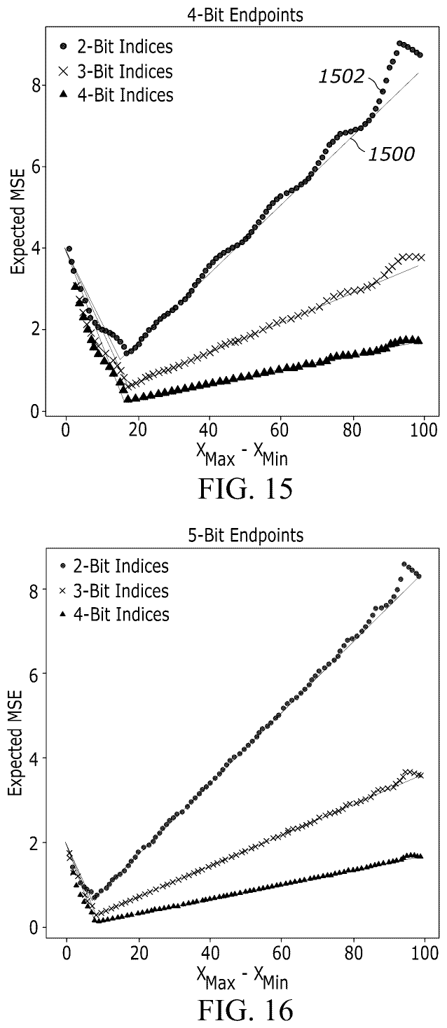

FIGS. 15-18 respectively show the expected MAE error and approximated error for respective endpoint precisions of 4-bit, 5-bit, 6-bit, and 7-bit. In each of these figures, the top pair of curves represents 2-bit indices, the middle pair represents 3-bit indices, and the bottom pair represents 4-bit indices, with the combined error term 1500 in FIG. 15 as an example (2-bit indices) being superimposed with its piecewise linear function approximation 1502. It is to be understood that the other pairs of curves in FIGS. 15-18 likewise are composed of the combined error representation and corresponding piecewise linear function approximation.

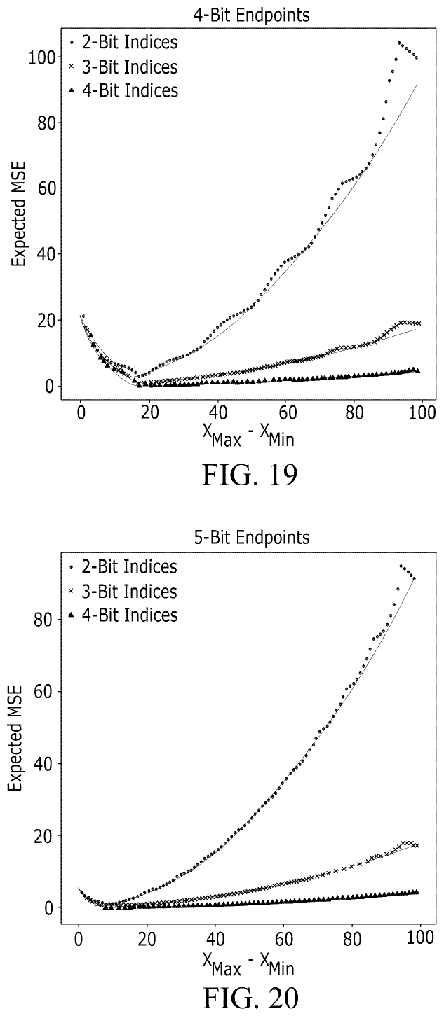

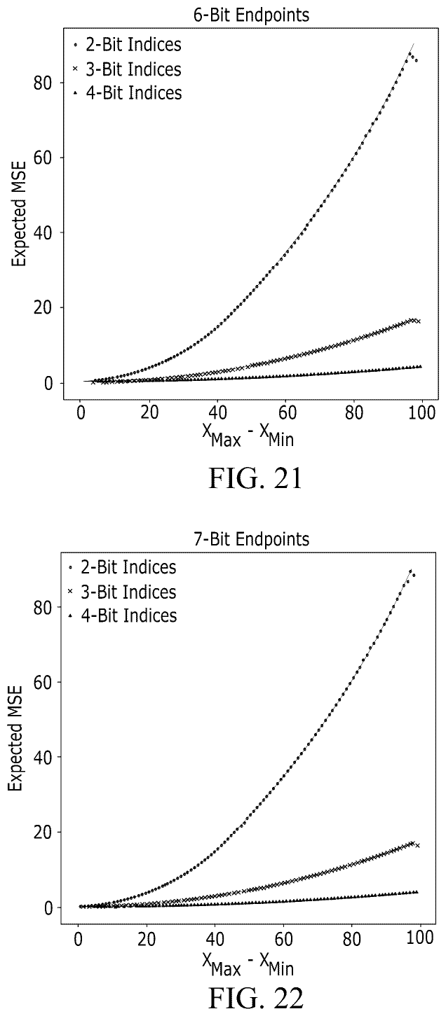

FIGS. 19-22 respectively show the expected MSE error and approximated error for respective endpoint precisions of 4-bit, 5-bit, 6-bit, and 7-bit similar to the MAE cases shown in FIGS. 15-18, in which a piecewise quadratic function can be used to approximate MSE combined quantization error.

While particular techniques are herein shown and described in detail, it is to be understood that the subject matter which is encompassed by the present application is limited only by the claims.

What is claimed is:

1. An apparatus comprising:
at least one processor system configured to:
for at least a first block of computer graphics texture data, determine a projection error estimate, an endpoint quantization error estimate, and an interpolation index quantization error estimate for plural block compression (BC) modes;
based at least in part on the estimates, select a first one of the BC modes; and
compress the first block using the first mode.

2. The apparatus of claim 1, wherein the plural BC modes comprise plural BC7 modes.

3. The apparatus of claim 1, wherein the processor system is configured to:
render the texture data on at least one video display at least in part by processing the first block compressed using the first mode.

4. The apparatus of claim 1, wherein the processor system is configured to:
select the first one of the BC modes responsive to the first one of the BC modes having a lowest total sum of the estimates among the BC modes.

5. The apparatus of claim 2, wherein the processor system is configured to:
determine a first projection error estimate for BC7 mode 6, a second projection error estimate for BC7 modes 4 and 5, a third projection error estimate for at least BC7 modes 1 and 3, and a fourth projection error estimate for BC7 modes 0 and 2.

6. The apparatus of claim 1, wherein the processor system is configured to:
determine individual respective endpoint quantization error estimates for respective BC7 modes 0, 1, 2, 3, 4, 5, 6, and 7.

7. The apparatus of claim 1, wherein the processor system is configured to:
determine individual respective interpolation quantization error estimates for respective BC7 modes 0, 1, 2, 3, 4, 5, 6, and 7.

8. The apparatus of claim 1, wherein the processor system is configured to:
determine the interpolation index quantization error estimate at least in part by quantizing interpolation index values from a set of scalar values in a range to N-bits.

9. The apparatus of claim 1, wherein the processor system is configured to:
determine the interpolation index quantization error estimate at least in part by quantizing interpolation index values from a uniformly distributed set of scalar values in a range to N-bits of precision and quantizing endpoints in the values to M-bits of precision; and
approximate a combined error term from the quantizing to a piecewise linear function.

10. The apparatus of claim 1, wherein the processor system is configured to:
determine the interpolation index quantization error estimate at least in part by quantizing interpolation index values from a distributed set of scalar values in a range to N-bits of precision and quantizing endpoints in the values to M-bits of precision; and
approximate a combined error term from the quantizing to a piecewise quadratic function.

11. A device comprising:
at least one computer storage that is not a transitory signal and that comprises instructions executable by at least one processor system to:
select a block compression (BC)7 mode of compression with which to compress at least one block of data without compressing the block with every available mode of compression to determine which mode minimizes compression error least in part using projection error estimates and/or endpoint quantization error estimates and/or interpolation index quantization error estimates for plural BC7 modes.

12. The device of claim 11, wherein the instructions are executable to:
associate a projection error estimate, an endpoint quantization error estimate, and an interpolation index quantization error estimate to respective BC7 modes; and
compress the block of data using a BC7 mode having a lowest sum of projection error estimate, endpoint quantization error estimate, and interpolation index quantization error estimate than is associated with any other mode.

13. The device of claim 11, wherein the at least one block of data comprises a first block of computer graphics texture data.

14. The device of claim 11, wherein the instructions are executable to:
render the data on at least one video display at least in part by processing the at least one block.

15. The device of claim 11, wherein the instructions are executable to:
determine a first projection error estimate for BC7 mode 6, a second projection error estimate for BC7 modes 4 and 5, a third projection error estimate at least for BC7 modes 1 and 3, and a fourth projection error estimate for BC7 modes 0 and 2.

16. The device of claim 11, wherein the instructions are executable to:
determine individual respective endpoint quantization error estimates for respective BC7 modes 0, 1, 2, 3, 4, 5, 6, and 7.

17. The device of claim 11, wherein the instructions are executable to:
determine individual respective interpolation quantization error estimates for respective BC7 modes 0, 1, 2, 3, 4, 5, 6, and 7.

18. The device of claim 11, wherein the instructions are executable to:
determine the interpolation index quantization error estimate at least in part by quantizing interpolation index values from a set of scalar values in a range to N-bits.

19. A method, comprising:
determining one or more estimates of errors related to potential compression of a block of information; and
using the one or more estimates and without compressing the block with every available mode of compression to determine which mode minimizes compression error, select a mode of compression to compress the block using the one or more estimates.

20. The method of claim 19, wherein the information comprises texture information, the modes of compression comprise block compression (BC)7 modes of compression, the one or more estimates of errors comprise projection error estimates, endpoint quantization error estimates, and interpolation index quantization error estimates for plural BC7 modes, and the method comprises:
using all of the estimates, selecting the mode of compression to compress the block;
compressing the block using the selected mode; and
rendering the texture at least in part by processing the block compressed using the selected mode.
